(19) United States
(12) Patent Application Publication
(10) Pub. No.: US 2025/0191505 A1
(43) Pub. Date: Jun. 12, 2025

(54) DISPLAY APPARATUS AND METHOD OF OPERATING THE SAME

(71) Applicant: Samsung Display Co., LTD., Yongin-si (KR)

(72) Inventors: MIYOUNG JOO, Yongin-si (KR); KANGHEE LEE, Yongin-si (KR); TONGILL KWAK, Yongin-si (KR); JUSEO KIM, Yongin-si (KR); JONG-WOONG PARK, Yongin-si (KR); Jinhwan Cho, Yongin-si (KR)

(21) Appl. No.: 18/949,890

(22) Filed: Nov. 15, 2024

(30) Foreign Application Priority Data
Dec. 8, 2023 (KR) 10-2023-0178156

(51) Int. Cl. G09G 3/00; G09G 3/20

(52) U.S. Cl. CPC G09G 3/006; G09G 3/2007; G09G 2320/0233; G09G 2320/045; G09G 2320/048; G09G 2330/12

(57) ABSTRACT

A display apparatus may include a display panel including a pixel, a gate driver configured to apply a gate signal to the pixel, a data driver configured to apply a data voltage based on a data signal to the pixel, and a driving controller configured to control the gate driver and the data driver, configured to output the data signal, and including a stress converter configured to generate deterioration data based on input image data, an integrated predict function storer configured to output modeling compensation data, which includes a light-emitting element compensation data and driving transistor compensation data, based on an integrated predict function representing the deterioration data and a luminance reduction rate, and a deterioration compensator configured to generate the data signal by compensating the input image data based on the modeling compensation data.

### CROSS-REFERENCE TO RELATED APPLICATION

The present application claims priority to, and the benefit of, Korean Patent Application No. 10-2023-0178156, filed on Dec. 8, 2023 in the Korean Intellectual Property Office KIPO, the entire disclosure of which is herein incorporated by reference.

### BACKGROUND

### 1. Field

Embodiments of the present disclosure relate to a display apparatus for compensating a deterioration of a display panel, and a method of operating the display apparatus.

### 2. Description of the Related Art

Generally, a display apparatus includes a display panel, and a display panel driver. The display panel includes a plurality of gate lines, a plurality of data lines, a plurality of emission lines, a plurality of power voltage lines and a plurality of pixels. The display panel driver includes a gate driver for providing a gate signal to the gate lines, a data driver for providing a data voltage to the data lines, an emission driver for providing an emission signal to the emission lines, and a driving controller for controlling the gate driver, the data driver, and the emission driver.

Generally, a function for compensating a light-emitting element and a function for compensating a driving transistor may be stored in a conventional display apparatus.

### SUMMARY

Embodiments of the present disclosure provide a display apparatus for compensating a deterioration of a display panel by using an integrated predict function.

Embodiments of the present disclosure also provide a method of operating the display apparatus.

In one or more embodiments of a display apparatus according to the present disclosure, the display apparatus may include a display panel including a pixel, a gate driver configured to apply a gate signal to the pixel, a data driver configured to apply a data voltage based on a data signal to the pixel, and a driving controller configured to control the gate driver and the data driver, configured to output the data signal, and including a stress converter configured to generate deterioration data based on input image data, an integrated predict function storer configured to output modeling compensation data, which includes a light-emitting element compensation data and driving transistor compensation data, based on an integrated predict function representing the deterioration data and a luminance reduction rate, and a deterioration compensator configured to generate the data signal by compensating the input image data based on the modeling compensation data.

The integrated predict function may be configured to be generated based on a luminance deterioration coefficient and a deterioration time.

The luminance deterioration coefficient may include a ratio of a reference grayscale deterioration rate to a first grayscale deterioration rate.

The deterioration data may represent a first deterioration time, wherein the light-emitting element compensation data is configured to be generated based on a first deterioration ratio including a ratio of a value of a reference integrated predict function in the first deterioration time to a value of a target integrated predict function in the first deterioration time.

The light-emitting element compensation data may be configured to be generated based on a light-emitting element compensation look-up table and the first deterioration ratio.

The deterioration data may further represent a second deterioration time that is different from the first deterioration time, wherein the light-emitting element compensation data is configured to be changed based on a second deterioration ratio including a ratio of a value of a reference integrated predict function in the second deterioration time to a value of a target integrated predict function in the second deterioration time.

The deterioration data may represent a first deterioration time, wherein the driving transistor compensation data is configured to be generated based on a value of a target integrated predict function in the first deterioration time.

The driving transistor compensation data may be configured to be generated based on the value of the target integrated predict function in the first deterioration time and a driving transistor compensation look-up table.

The deterioration data may further represent a second deterioration time that is different from the first deterioration time, wherein the driving transistor compensation data is configured to be generated based on a value of the target integrated predict function in the second deterioration time.

The driving controller may further include an initial distribution function storer and a final compensation signal outputter, wherein the initial distribution function storer is configured to output initial distribution compensation data based on an initial distribution predict function, wherein the final compensation signal outputter is configured to output a final compensation data signal based on the modeling compensation data and the initial distribution compensation data, and wherein the deterioration compensator is configured to output the data signal based on the final compensation data signal and the input image data.

The final compensation data signal may be configured to be generated based on a product of the initial distribution compensation data and the modeling compensation data.

The initial distribution predict function may be configured to be generated based on initial state data of the display panel.

The initial distribution predict function may be configured to be stored in the initial distribution function storer during a manufacturing process.

The integrated predict function may be configured to be stored in the integrated predict function storer during a manufacturing process.

In one or more embodiments of a method of operating a display apparatus according to the present disclosure, the method may include determining deterioration data, determining modeling compensation data, which includes light-emitting element compensation data and driving transistor compensation data, based on the deterioration data and an integrated predict function, and outputting a data signal based on the modeling compensation data.

The method may further include determining initial distribution compensation data based on initial distribution data, and determining a final compensation signal based on the modeling compensation data and the initial distribution compensation data, wherein the data signal is based on the final compensation signal.

The integrated predict function may be based on a luminance deterioration coefficient and a deterioration time.

The luminance deterioration coefficient may include a ratio of a reference grayscale deterioration rate to a first grayscale deterioration rate.

The deterioration data may represent a first deterioration time, wherein the light-emitting element compensation data is based on a first deterioration ratio, which is a ratio of a value of a reference integrated predict function in the first deterioration time to a value of a target integrated predict function in the first deterioration time.

The deterioration data may represent a first deterioration time, wherein the driving transistor compensation data is based on a value of a target integrated predict function in the first deterioration time.

According to the display apparatus, a light-emitting element compensation data and a driving transistor compensation data may be generated by using an integrated predict function. Accordingly, a usage of a memory of the display apparatus may be reduced. Additionally, a power consumption of the display apparatus may be reduced.

### BRIEF DESCRIPTION OF THE DRAWINGS

The above and other aspects of the present disclosure will become more apparent by describing in detailed embodiments thereof with reference to the accompanying drawings, in which:

FIG. 1 is a block diagram illustrating a display apparatus according to one or more embodiments of the present disclosure.

FIG. 2 is a block diagram illustrating a driving controller of FIG. 1.

FIG. 3 is a block diagram illustrating a state of a display panel in a first time for generating an integrated predict function included in a display apparatus of FIG. 1.

FIG. 4 is a block diagram illustrating a state of a display panel in a second time for generating an integrated predict function included in a display apparatus of FIG. 1.

FIG. 5 is a diagram illustrating a luminance deterioration coefficient for generating an integrated predict function included in a display apparatus of FIG. 1.

FIG. 6 is a graph illustrating a deterioration ratio for a display apparatus of FIG. 1 to generate a light-emitting element compensation data.

FIG. 7 is a graph illustrating a change according to a deterioration time of a driving transistor of a display apparatus of FIG. 1.

FIG. 8 is a flow chart illustrating a flow in which a driving controller of FIG. 1 outputs a data signal.

FIG. 9 is a block diagram illustrating an electronic apparatus according to one or more embodiments of the present disclosure.

FIG. 10 is a diagram illustrating an example in which the electronic apparatus of FIG. 9 is implemented as a smart phone.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted.

Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that the present disclosure covers all modifications, equivalents, and replacements within the idea and technical scope of the present disclosure, that each of the features of embodiments of the present disclosure may be combined with each other, in part or in whole, and technically various interlocking and operating are possible, and that each embodiment may be implemented independently of each other, or may be implemented together in an association, unless otherwise stated or implied.

It will be understood that when an element, layer, region, or component is referred to as being “formed on,” “on,” “connected to,” or “(operatively or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a resistor, a capacitor, and/or the like. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.”

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

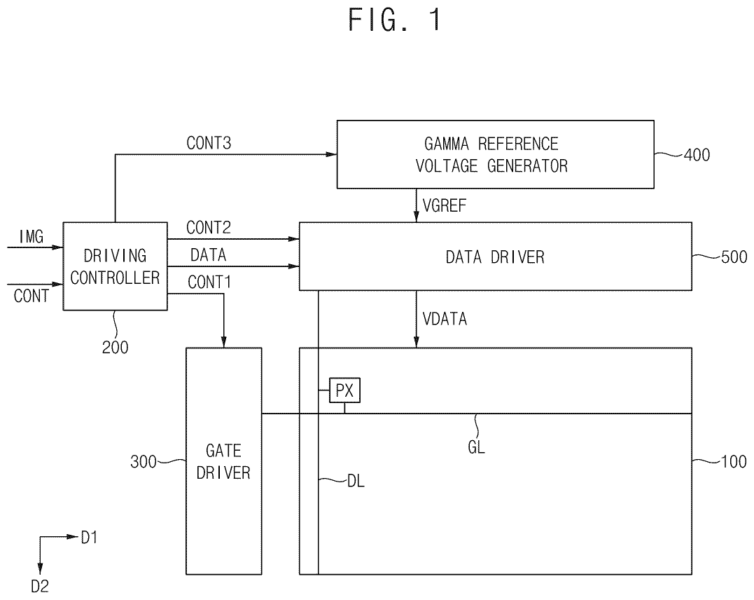

FIG. 1 is a block diagram illustrating a display apparatus according to one or more embodiments of the present disclosure.

Referring to FIG. 1, the display apparatus includes a display panel 100 and a display panel driver. In one or more embodiments, the display panel driver includes a driving controller 200, a gate driver 300, a gamma reference voltage generator 400, and a data driver 500.

The display panel 100 has a display region on which an image is displayed, and a peripheral region adjacent to the display region.

The display panel 100 includes gate lines GL, data lines DL, and pixel circuit PX connected to at least one of the gate lines GL and to one of the data lines DL. The gate lines GL may extend in a first direction D1. The data lines DL may extend in a second direction D2 crossing the first direction D1.

In one or more embodiments, the pixel circuit PX may include a driving transistor and a light-emitting element. For example, the driving transistor may generate a driving current based on a data voltage VDATA. For example, the light-emitting element may emit light based on the driving current. In one or more embodiments, the light-emitting element may be any suitable light-emitting element. For example, the light-emitting element may be a nano light-emitting diode NED, a quantum dot QD light-emitting diode, a micro light-emitting diode, an inorganic light-emitting diode, or any other suitable light-emitting element.

The driving controller 200 may receive input image data IMG and an input control signal CONT from an external apparatus. For example, the input image data IMG may include red image data, green image data, and blue image data. For example, the input image data IMG may include white image data. For example, the input image data IMG may include magenta image data, yellow image data, and cyan image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3, and a data signal DATA based on the input image data IMG and the input control signal CONT.

The driving controller 200 generates the first control signal CONT1 for controlling an operation of the gate driver 300 based on the input control signal CONT, and outputs the first control signal CONT1 to the gate driver 300. The first control signal CONT1 may include a vertical start signal and a gate clock signal.

The driving controller 200 generates the second control signal CONT2 for controlling an operation of the data driver 500 based on the input control signal CONT, and outputs the second control signal CONT2 to the data driver 500. The second control signal CONT2 may include a horizontal start signal and a load signal.

The driving controller 200 generates the data signal DATA based on the input image data IMG. The driving controller 200 outputs the data signal DATA to the data driver 500.

The driving controller 200 generates the third control signal CONT3 for controlling an operation of the gamma reference voltage generator 400 based on the input control signal CONT, and outputs the third control signal CONT3 to the gamma reference voltage generator 400.

The gate driver 300 generates gate signals for driving the gate lines GL in response to the first control signal CONT1 received from the driving controller 200. The gate driver 300 may output the gate signals to the gate lines GL.

In one or more embodiments of the present disclosure, the gate driver 300 may be integrated on the peripheral region of the display panel 100. In one or more embodiments of the present disclosure, the gate driver 300 may be mounted on the peripheral region of the display panel 100.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500. The gamma reference voltage VGREF has a value corresponding to each of the data signal DATA.

For example, the gamma reference voltage generator 400 may be located in the driving controller 200 or in the data driver 500.

The data driver 500 receives the second control signal CONT2 and the data signal DATA from the driving controller 200, and receives the gamma reference voltages VGREF from the gamma reference voltage generator 400.

In one or more embodiments of the present disclosure, the data driver 500 may be integrated on the peripheral region of the display panel 100. In one or more embodiments of the present disclosure, the data driver 500 may be mounted on the peripheral region of the display panel 100.

The data driver 500 converts the data signal DATA into data voltages VDATA having an analog type using the gamma reference voltages VGREF. The data driver 500 outputs the data voltages VDATA to the data line DL.

In one or more embodiments, the data driver 500 may be implemented with one or more integrated circuits. In one or more other embodiments, the data driver 500 and the driving controller 200 may be implemented as a single integrated circuit, which may be referred to as a timing controller embedded data driver (TED).

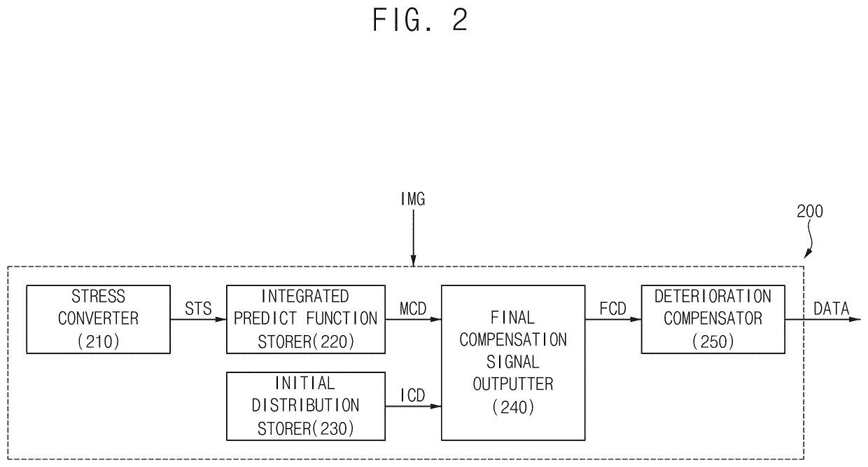

FIG. 2 is a block diagram illustrating a driving controller 200 of FIG. 1.

Referring to FIG. 1 and FIG. 2, the driving controller 200 may include a stress converter 210, an integrated predict function storer 220, an initial distribution function storer 230, a final compensation signal outputter 240, and a deterioration compensator 250.

The stress converter 210 may output deterioration data STS of the display panel 100. For example, the stress converter 210 may determine the deterioration data STS based on the input image data IMG. In one or more embodiments, the stress converter 210 may generate the deterioration data STS. For example, the deterioration data STS may be a value based on data of at least one of a display luminance, temperature, a current of the display panel 100, and/or a voltage of the display panel 100. For example, the deterioration data STS may include data of a deterioration time, a deterioration grayscale, and/or etc.

In one or more embodiments, the stress converter 210 may further include a volatile memory for storing the calculated deterioration data STS. For example, the volatile memory may be a random access memory (RAM). For example, the volatile memory may be a static random access memory (SRAM). However, the present disclosure is not limited to the type of the volatile memory.

In one or more embodiments, the display apparatus may further include a non-volatile memory for storing the deterioration data STS, which is calculated by the stress converter 210. For example, the non-volatile memory may be a flash memory. However, the present disclosure is not limited to a type of the non-volatile memory. In one or more embodiments, the non-volatile memory may be included in the driving controller 200.

The integrated predict function storer 220 may receive the deterioration data STS. The integrated predict function storer 220 may output modeling compensation data MCD based on the deterioration data STS and an integrated predict function. For example, the integrated predict function storer 220 may output the modeling compensation data MCD based the deterioration time and the integrated predict function corresponding to on the deterioration grayscale. The integrated predict function may be generated based on a luminance deterioration coefficient. In one or more embodiments, the integrated predict function may be stored in the integrated predict function storer 220 in a manufacturing process.

The modeling compensation data MCD may include a light-emitting element compensation data and a driving transistor compensation data. The light-emitting element compensation data may be data for compensating a deterioration of the light-emitting element. The driving transistor compensation data may be data for compensating a deterioration of the driving transistor.

Generally, a light-emitting element predict function for compensating the light-emitting element and a driving transistor predict function for compensating the driving transistor may be generated respectively. The light-emitting element predict function and the driving transistor predict function may be stored in a conventional display apparatus. Accordingly, a memory usage of the conventional display apparatus may be increased, and a power consumption of the conventional display apparatus may be increased.

In contrast, the display apparatus according to the present disclosure may generate the light-emitting element compensation data and the driving transistor compensation data based the integrated predict function. Accordingly, a memory usage of the display apparatus may be decreased. Accordingly, an integration of the display apparatus may be improved. Additionally, a power consumption of the display apparatus may be reduced.

The initial distribution function storer 230 may output initial distribution compensation data ICD. For example, the initial distribution compensation data ICD may be determined based on an initial distribution predict function stored in the initial distribution function storer 230. In one or more embodiments, the initial distribution predict function may be stored in the initial distribution function storer 230 in a manufacturing process. For example, the initial distribution predict function may have a look-up table format. However, the present disclosure is not limited to a format of the initial distribution predict function.

The initial distribution compensation data ICD may be determined based on the initial distribution predict function and initial distribution data. For example, the initial distribution data may include initial state data of the display panel. For example, the initial state data may include initial threshold voltage data of transistors included in the pixel a characteristic data of the light-emitting element, a deposition time in the manufacturing process of the display panel, set color matrix of the display panel, a luminous efficiency data of the display panel, initial luminance data of the display panel and/or etc. However, the present disclosure is not limited to a type of data included in the initial state data. For example, the initial distribution compensation data ICD may be different according to a region of the display panel 100.

The final compensation signal outputter 240 may output a final compensation data signal FCD based on the modeling compensation data MCD and the initial distribution compensation data ICD. For example, the final compensation data signal FCD may be outputted based on a product of the modeling compensation data MCD and the initial distribution compensation data ICD. However, the present disclosure is not limited to a method of determining the final compensation data signal FCD by using the initial distribution compensation data ICD.

The deterioration compensator 250 may output the data signal DATA based on the input image data IMG and the final compensation data signal FCD. For example, the deterioration compensator 250 may generate the data signal DATA by compensating the input image data IMG based on the final compensation data signal FCD.

The data signal DATA may be data in which the effects of deterioration of the light-emitting element and the deterioration of the driving transistor are compensated.

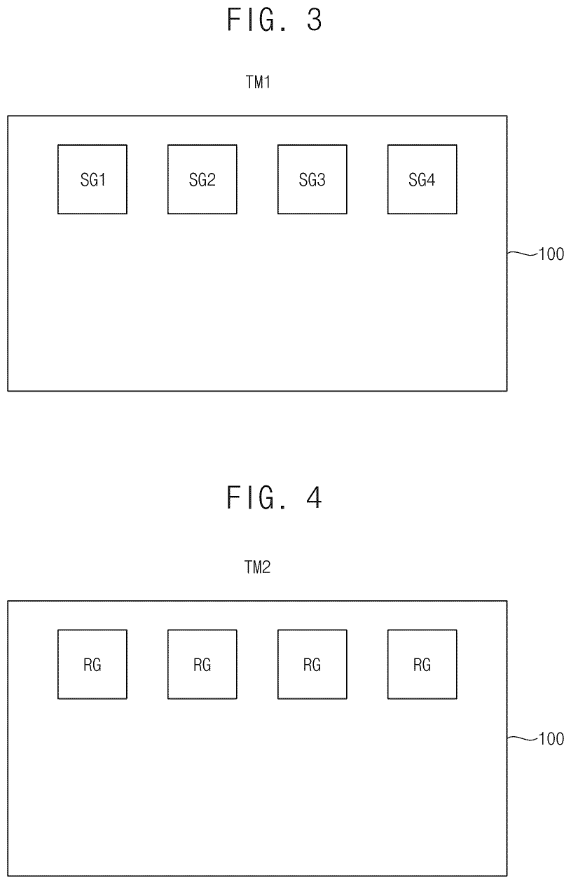

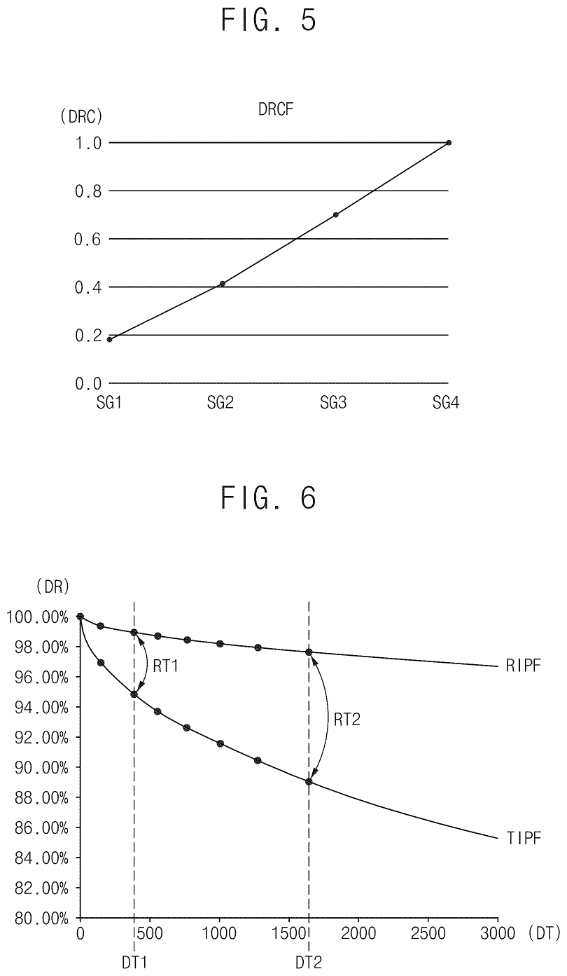

FIG. 3 is a block diagram illustrating a state of a display panel in a first time TM1 for generating an integrated predict function included in a display apparatus of FIG. 1. FIG. 4 is a block diagram illustrating a state of a display panel in a second time TM2 for generating an integrated predict function included in a display apparatus of FIG. 1. FIG. 5 is a diagram illustrating a luminance deterioration coefficient DRC for generating an integrated predict function included in a display apparatus of FIG. 1.

Referring to FIG. 1 to FIG. 5, in the first time TM1, the display panel 100 may include a first grayscale region that emits light as a first grayscale SG1, a second grayscale region that emits light as a second grayscale SG2, a third grayscale region that emits light as a third grayscale SG3, and a fourth grayscale region that emits light as a fourth grayscale SG4. For example, the first grayscale SG1, the second grayscale SG2, the third grayscale SG3, and the fourth grayscale SG4 may be different. For example, the first grayscale SG1 may be about 0grayscale, the second grayscale SG2 may be about 31grayscale, the third grayscale SG3 may be about 96grayscale, and the fourth grayscale SG4 may be about 255grayscale. However, the present disclosure is not limited to a value of the first grayscale SG1, the second grayscale SG2, the third grayscale SG3, and the fourth grayscale SG4. For example, the first grayscale SG1, the second grayscale SG2, the third grayscale SG3, and the fourth grayscale SG4 may be set by user. Additionally, the present disclosure is not limited to the number of a grayscale region included in the display panel 100. For example, the display panel 100 may include a fifth grayscale region that emits light as a fifth grayscale. From the first time TM1 to the second TM2, the first grayscale region may emit light as the first grayscale SG1, the second grayscale region may emit light as the second grayscale SG2, the third grayscale region may emit light as the third grayscale SG3, and the fourth grayscale region may emit light as the fourth grayscale SG4.

At the second time TM2, the first grayscale region, the second grayscale region, the third grayscale region, and the fourth grayscale region may emit light as a reference grayscale RG. For example, the reference grayscale RG may be about 127grayscale. However, the present disclosure is not limited to a value of the reference grayscale RG. For example, the reference grayscale RG may be about 0grayscale.

A difference between a luminance of the first grayscale region at the first time and a luminance of the first grayscale region at the second time may be defined as a first luminance reduction rate. A difference between a luminance of the second grayscale region at the first time and a luminance of the second grayscale region at the second time may be defined as a second luminance reduction rate. A difference between a luminance of the third grayscale region at the first time and a luminance of the third grayscale region at the second time may be defined as a third luminance reduction rate. A difference between a luminance of the fourth grayscale region at the first time and a luminance of the fourth grayscale region at the second time may be defined as a fourth luminance reduction rate.

Generally, when the display panel emits light as different luminance, the luminance reduction rate may be different. Accordingly, the first luminance reduction rate, the second luminance reduction rate, the third luminance reduction rate, and the fourth luminance reduction rate may be different. For example, when the display panel emits light as a high grayscale, the luminance reduction rate may be high. For example, when the display panel emits light as a low grayscale, the luminance reduction rate may be low.

One of the first to fourth luminance reduction rate may be chosen as a reference luminance reduction rate. For example, as shown in FIG. 5, the fourth luminance reduction rate may be chosen as the reference luminance reduction rate. The luminance deterioration coefficient DRC may be defined as ratios of the reference luminance reduction rate to each of the first to fourth luminance reduction rates. For example, a ratio of the reference luminance reduction rate to the first luminance reduction rate may be a first luminance deterioration coefficient. For example, a ratio of the reference luminance reduction rate to the second luminance reduction rate may be a second luminance deterioration coefficient. For example, a ratio of the reference luminance reduction rate to the third luminance reduction rate may be a third luminance deterioration coefficient. For example, a ratio of the reference luminance reduction rate to the fourth luminance reduction rate may be a fourth luminance deterioration coefficient.

For example, when the fourth luminance reduction ratio is chosen as the reference luminance reduction rate, the luminance deterioration coefficient DRC corresponding to the fourth grayscale SG4 may be about 1.0. The luminance deterioration coefficient DRC corresponding to the third grayscale SG3 may be a ratio of the fourth luminance reduction rate to the third luminance reduction rate. For example, the luminance deterioration coefficient DRC corresponding to the third grayscale SG3 may be about 0.7. The luminance deterioration coefficient DRC corresponding to the second grayscale SG2 may be a ratio of the fourth luminance reduction rate to the second luminance reduction rate. For example, the luminance deterioration coefficient DRC corresponding to the second grayscale SG2 may be about 0.4. The luminance deterioration coefficient DRC corresponding to the first grayscale SG1 may be a ratio of the fourth luminance reduction rate to the first luminance reduction rate. For example, the luminance deterioration coefficient DRC corresponding to the first grayscale SG1 may be about 0.2. However, the present disclosure is not limited to a value of the coefficient. Additionally, the present disclosure is not limited to a grayscale value of the reference luminance reduction rate. For example, the reference luminance reduction rate may be chosen as the first luminance reduction rate.

In one or more embodiments, a luminance deterioration coefficient function DRCF may be generated by modeling the luminance deterioration coefficient DRC corresponding to the first to fourth grayscales SG1, SG2, SG3, and SG4. For example, the luminance deterioration coefficient function DRCF may be generated by modeling the first luminance deterioration coefficient, the second luminance deterioration coefficient, the third luminance deterioration coefficient, and the fourth luminance deterioration coefficient. The luminance deterioration coefficient function DRCF may have a look-up table format. However, the present disclosure is not limited to a format of the luminance deterioration coefficient function DRCF.

The integrated predict function may be generated by using the luminance deterioration coefficient DRC. For example, the integrated predict function may be generated by using a First Equation. However, the present disclosure is not limited to a method of using the luminance deterioration coefficient DRC in the integrated prediction function.

$$IPF = exp [ - S * {( C * t * ( {( \frac{L}{L r e f} )}^{a c c} ) )}^{1 / T} \qquad First Equation$$

Herein, IPF may refer to the integrated predict function. S and T may respectively refer to a coefficient based on a characteristic of the display panel. C may refer to a temperature acceleration coefficient. t may refer to a deterioration time. Lref may refer to a grayscale corresponding to the reference luminance reduction rate. L may refer to a chosen grayscale. acc may refer to the luminance deterioration coefficient DRC corresponding to the chosen grayscale.

The integrated predict function corresponding to the first grayscale SG1 may be a first integrated predict function. The integrated predict function corresponding to the second grayscale SG2 may be a second integrated predict function. The integrated predict function corresponding to the third grayscale SG3 may be a third integrated predict function. The integrated predict function corresponding to the fourth grayscale SG4 may be a fourth integrated predict function. However, the present disclosure is not limited to the number of the integrated predict function.

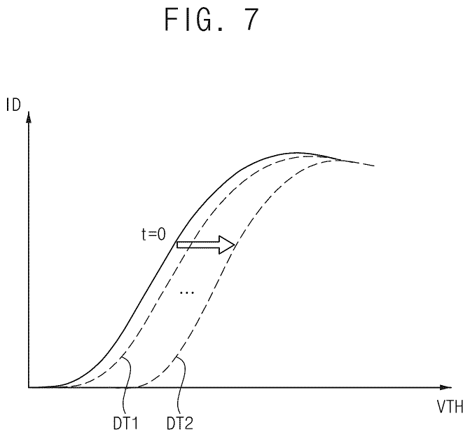

FIG. 6 is a graph illustrating a deterioration ratio for a display apparatus of FIG. 1 to generate a light-emitting element compensation data. FIG. 7 is a graph illustrating a change according to a deterioration time DT of a driving transistor of a display apparatus of FIG. 1.

Referring to FIG. 1 to FIG. 7, one of the first to fourth integrated predict functions may be chosen as a reference integrated predict function RIPF. One of the first to fourth integrated predict functions may be chosen as a target integrated predict function TIPF.

A deterioration ratio may be a ratio of a value of the reference integrated predict function RIPF in the deterioration DT to a value of the target integrated predict function TIPF in the deterioration DT. The light-emitting element compensation data corresponding to the deterioration ratio may be generated.

In one or more embodiments, the light-emitting element compensation data may be generated by using the deterioration ratio and the light-emitting element compensation look-up table. In one or more embodiments, the light-emitting element compensation look-up table may be stored in the driving controller 200. The light-emitting element compensation look-up table may be composed of the deterioration rate and the light-emitting element compensation data corresponding to the deterioration rate.

For example, a first deterioration ratio RT1 may be a ratio of a value of the reference integrated predict function RIPF in a first deterioration time DT1 to a value of the target integrated predict function TIPF in the first deterioration time DT1. For example, a second deterioration ratio RT2 may be a ratio of a value of the reference integrated predict function RIPF in a second deterioration time DT2 that is different from the first deterioration time DT1 to a value of the target integrated predict function TIPF in the second deterioration time DT2. The first deterioration time DT1 and the second deterioration time DT2 may be different, the first deterioration ratio RT1 and the second deterioration ratio RT2 may be different. Accordingly, the light-emitting element compensation data corresponding to the first deterioration time DT1 and the light-emitting element compensation data corresponding to the second deterioration time DT2 may be different.

As shown in FIG. 7, a characteristic of a threshold voltage VTH of the driving transistor according to the deterioration time DT may be changed. The characteristic of the threshold voltage VTH may be changed, so that the driving current ID may be changed. Although FIG. 7 illustrates that the threshold voltage VTH is shown to move in a positive direction as the deterioration time DT increases, the threshold voltage VTH may also move in a negative direction.

The driving transistor compensation data signal may be generated based on the integrated predict function. In one or more embodiments, the driving transistor compensation data signal may be generated by using the deterioration time DT and a driving transistor compensation look-up table. In one or more embodiments, the driving transistor look-up table may be stored in the driving controller 200. The driving transistor compensation look-up table may be composed of the deterioration rate DT and the driving transistor compensation data corresponding to the deterioration rate DT.

Generally, a light-emitting element predict function for compensating the light-emitting element and a driving transistor predict function for compensating the driving transistor may be generated respectively. The light-emitting element predict function and the driving transistor predict function may be stored in a conventional display apparatus. Accordingly, a memory usage of the conventional display apparatus may be increased, and a power consumption of the conventional display apparatus may be increased.

In contrast, the display apparatus according to the present disclosure may generate the light-emitting element compensation data and the driving transistor compensation data based the integrated predict function. Accordingly, a memory usage of the display apparatus may be decreased. Accordingly, an integration of the display apparatus may be improved. Additionally, a power consumption of the display apparatus may be reduced.

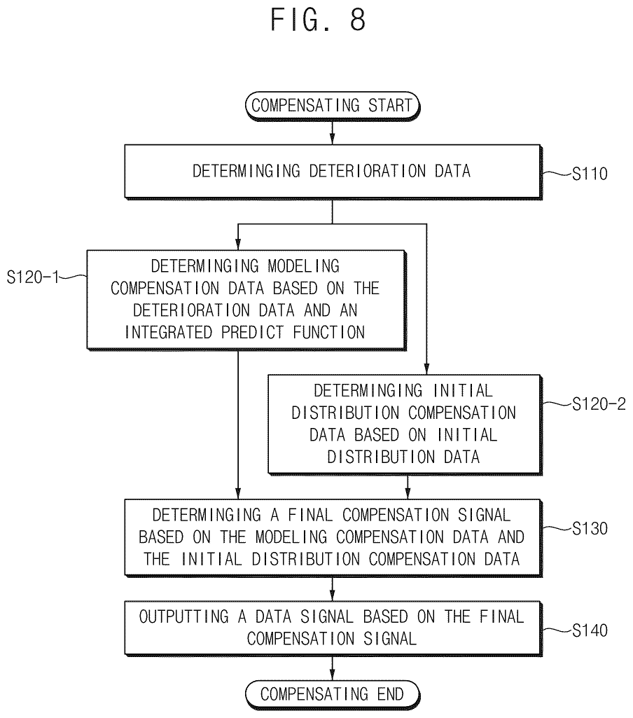

FIG. 8 is a flow chart illustrating a flow in which a driving controller of FIG. 1 outputs a data signal.

Referring to FIG. 1 and FIG. 8, the deterioration data may be determined (S110). The modeling compensation data may be determined based on the deterioration data and the integrated predict function (S120-1). An initial distribution data may be determined based on the initial distribution data (S120-2).

A final compensation signal may be determined based on the modeling compensation data and the initial distribution compensation data (S130). The data signal DATA may be outputted based on the final compensation signal (S140).

The modeling compensation data may be determined based on the integrated predict function. The modeling compensation data may include the light-emitting element compensation data and the driving transistor compensation data.

Generally, a light-emitting element predict function for compensating the light-emitting element, and a driving transistor predict function for compensating the driving transistor, may be generated respectively. The light-emitting element predict function and the driving transistor predict function may be stored in a conventional display apparatus. Accordingly, a memory usage of the conventional display apparatus may be increased, and a power consumption of the conventional display apparatus may be increased.

In contrast, the display apparatus according to the present disclosure may generate the light-emitting element compensation data and the driving transistor compensation data based the integrated predict function. Accordingly, a memory usage of the display apparatus may be decreased. Accordingly, an integration of the display apparatus may be improved. Additionally, a power consumption of the display apparatus may be reduced.

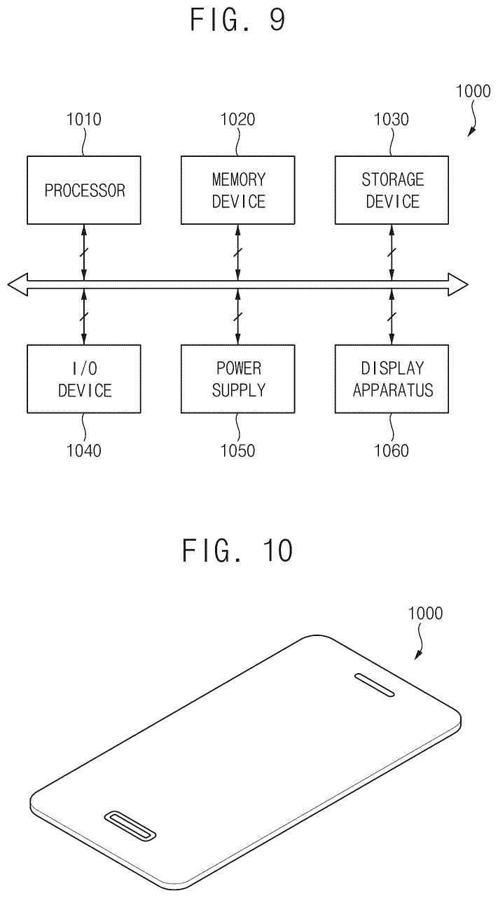

FIG. 9 is a block diagram illustrating an electronic apparatus according to one or more embodiments of the present disclosure. FIG. 10 is a diagram illustrating an example in which the electronic apparatus of FIG. 9 is implemented as a smart phone.

Referring to FIG. 9, the electronic apparatus 1000 may include a processor 1010, a memory device 1020, a storage device 1030, an input/output (I/O) device 1040, a power supply 1050, and a display apparatus 1060. Here, the display apparatus 1060 may be the display apparatus of FIG. 1. In addition, the electronic apparatus 1000 may further include a plurality of ports for communicating with a video card, a sound card, a memory card, a universal serial bus (USB) device, other electronic apparatuses, etc.

In one or more embodiments, as illustrated in FIG. 10, the electronic apparatus 1000 may be implemented as a smart phone. However, the electronic apparatus 1000 is not limited thereto. For example, the electronic apparatus 1000 may be implemented as a cellular phone, a video phone, a smart pad, a smart watch, a tablet PC, a car navigation system, a computer monitor, a laptop, a head mounted display (HMD) device, and the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG and the input control signal CONT to the driving controller 200 of FIG. 1.

The memory device 1020 may store data for operations of the electronic apparatus 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, and the like. The I/O device 1040 may include an input device such as a keyboard, a keypad, a mouse device, a touch-pad, a touch-screen, and the like and an output device such as a printer, a speaker, and the like. In some embodiments, the display apparatus 1060 may be included in the I/O device 1040. The power supply 1050 may provide power for operations of the electronic apparatus 1000. The display apparatus 1060 may be coupled to other components via the buses or other communication links.

In FIG. 10, the electronic apparatus of the present disclosure is implemented as a smartphone, but the present disclosure is not limited thereto. The electronic apparatus may be a television, a monitor, a laptop computer, or a tablet. Additionally, the electronic apparatus may be a car.

The display apparatus according to the embodiments may be applied to a display apparatus included in a computer, a notebook, a mobile phone, a smart phone, a smart pad, a PMP, a PDA, an MP3 player, or the like.

The foregoing is illustrative of the present disclosure and is not to be construed as limiting thereof. Although a few embodiments of the present disclosure have been described, those skilled in the art will readily appreciate that many modifications are possible in the embodiments without materially departing from the novel teachings and aspects of the present disclosure. Accordingly, all such modifications are intended to be included within the scope of the present disclosure as defined in the claims. In the claims, means-plus-function clauses are intended to cover the structures described herein as performing the recited function and not only structural equivalents but also equivalent structures. Therefore, it is to be understood that the foregoing is illustrative of the present disclosure and is not to be construed as limited to the embodiments disclosed, and that modifications to the disclosed embodiments, as well as other embodiments, are intended to be included within the scope of the appended claims. The present disclosure is defined by the following claims, with equivalents of the claims to be included therein.

What is claimed is:

1. A display apparatus comprising:
a display panel comprising a pixel;
a gate driver configured to apply a gate signal to the pixel;
a data driver configured to apply a data voltage based on a data signal to the pixel; and
a driving controller configured to control the gate driver and the data driver, configured to output the data signal, and comprising:
a stress converter configured to generate deterioration data based on input image data;
an integrated predict function storer configured to output modeling compensation data, which comprises a light-emitting element compensation data and driving transistor compensation data, based on an integrated predict function representing the deterioration data and a luminance reduction rate; and
a deterioration compensator configured to generate the data signal by compensating the input image data based on the modeling compensation data.

2. The display apparatus of claim 1, wherein the integrated predict function is configured to be generated based on a luminance deterioration coefficient and a deterioration time.

3. The display apparatus of claim 2, wherein the luminance deterioration coefficient comprises a ratio of a reference grayscale deterioration rate to a first grayscale deterioration rate.

4. The display apparatus of claim 1, wherein the deterioration data represents a first deterioration time, and
wherein the light-emitting element compensation data is configured to be generated based on a first deterioration ratio comprising a ratio of a value of a reference integrated predict function in the first deterioration time to a value of a target integrated predict function in the first deterioration time.

5. The display apparatus of claim 4, wherein the light-emitting element compensation data is configured to be generated based on a light-emitting element compensation look-up table and the first deterioration ratio.

6. The display apparatus of claim 4, wherein the deterioration data further represents a second deterioration time that is different from the first deterioration time, and
wherein the light-emitting element compensation data is configured to be changed based on a second deterioration ratio comprising a ratio of a value of a reference integrated predict function in the second deterioration time to a value of a target integrated predict function in the second deterioration time.

7. The display apparatus of claim 1, wherein the deterioration data represents a first deterioration time, and
wherein the driving transistor compensation data is configured to be generated based on a value of a target integrated predict function in the first deterioration time.

8. The display apparatus of claim 7, wherein the driving transistor compensation data is configured to be generated based on the value of the target integrated predict function in the first deterioration time and a driving transistor compensation look-up table.

9. The display apparatus of claim 7, wherein the deterioration data further represents a second deterioration time that is different from the first deterioration time, and
wherein the driving transistor compensation data is configured to be generated based on a value of the target integrated predict function in the second deterioration time.

10. The display apparatus of claim 1, wherein the driving controller further comprises an initial distribution function storer and a final compensation signal outputter,
wherein the initial distribution function storer is configured to output initial distribution compensation data based on an initial distribution predict function,
wherein the final compensation signal outputter is configured to output a final compensation data signal based on the modeling compensation data and the initial distribution compensation data, and
wherein the deterioration compensator is configured to output the data signal based on the final compensation data signal and the input image data.

11. The display apparatus of claim 10, wherein the final compensation data signal is configured to be generated based on a product of the initial distribution compensation data and the modeling compensation data.

12. The display apparatus of claim 10, wherein the initial distribution predict function is configured to be generated based on initial state data of the display panel.

13. The display apparatus of claim 12, wherein the initial distribution predict function is configured to be stored in the initial distribution function storer during a manufacturing process.

14. The display apparatus of claim 1, wherein the integrated predict function is configured to be stored in the integrated predict function storer during a manufacturing process.

15. A method of operating a display apparatus, the method comprising:
determining deterioration data;
determining modeling compensation data, which comprises light-emitting element compensation data and driving transistor compensation data, based on the deterioration data and an integrated predict function; and
outputting a data signal based on the modeling compensation data.

16. The method of claim 15, further comprising:
determining initial distribution compensation data based on initial distribution data; and
determining a final compensation signal based on the modeling compensation data and the initial distribution compensation data,
wherein the data signal is based on the final compensation signal.

17. The method of claim 15, wherein the integrated predict function is based on a luminance deterioration coefficient and a deterioration time.

18. The method of claim 17, wherein the luminance deterioration coefficient comprises a ratio of a reference grayscale deterioration rate to a first grayscale deterioration rate.

19. The method of claim 15, wherein the deterioration data represents a first deterioration time, and
wherein the light-emitting element compensation data is based on a first deterioration ratio, which is a ratio of a value of a reference integrated predict function in the first deterioration time to a value of a target integrated predict function in the first deterioration time.

20. The method of claim 15, wherein the deterioration data represents a first deterioration time, and
wherein the driving transistor compensation data is based on a value of a target integrated predict function in the first deterioration time.
